(19) United States
(12) Patent Application Publication
(10) Pub. No.: US 2014/0181724 A1
(43) Pub. Date: Jun. 26, 2014

(54) DISPLAY APPARATUS AND METHOD FOR PROVIDING MENU THEREOF

(71) Applicant: Samsung Electronics Co., Ltd., Suwon-si (KR)

(72) Inventor: Ji-won KIM, Seoul (KR)

(73) Assignee: Samsung Electronics Co., Ltd., Suwon-si (KR)

(21) Appl. No.: 14/140,951

(22) Filed: Dec. 26, 2013

(30) Foreign Application Priority Data
Dec. 26, 2012 (KR) 10-2012-0152727

(51) Int. Cl. G06F 3/0482; G06F 3/048

(52) U.S. Cl. CPC G06F 3/0482
USPC 715/775; 715/778

(57) ABSTRACT

Exemplary embodiments may disclose a display apparatus and a method for providing a menu thereof. The method for providing a menu of a display apparatus includes dividing the display apparatus into a plurality of areas, and displaying a plurality of images on each of the plurality of areas, displaying a simultaneous control menu which controls the plurality of images simultaneously in response to a predetermined first user command being input, and displaying an individual control menu which controls one of the plurality of images in response to a predetermined second user command being input.

### CROSS-REFERENCE TO RELATED APPLICATIONS

This application claims priority from Korean Patent Application No. 10-2012-0152727, filed in the Korean Intellectual Property Office on Dec. 26, 2012, the disclosure of which is incorporated herein by reference.

### BACKGROUND

1. Field

Aspects of the exemplary embodiments relate to a display apparatus and a method for providing a menu thereof. More particularly, exemplary embodiments relate to a display apparatus which is capable of dividing a display screen into a plurality of areas and displaying a plurality of images on each of the plurality of the divided areas, and a method for providing a menu thereof.

2. Description of the Related Art

A user demand for viewing various images on a display apparatus has been increasing. Therefore, a related art display apparatus may provide the function of dividing a display screen into a plurality of areas and displaying a plurality of images on each of the plurality of areas.

However, the related art display apparatus only provides a menu for controlling a plurality of images simultaneously (for example, a menu for image setting), and does not provide a menu for controlling each of a plurality of images displayed on a plurality of areas individually.

Therefore, it is difficult for a user to control only one image, from among a plurality of images displayed on each of a plurality of areas.

### SUMMARY

An aspect of the exemplary embodiments relates to a display apparatus which may provide a simultaneous control method for controlling a plurality of images displayed on each of a plurality of areas of a display screen at the same time and an individual control method for controlling a plurality of images individually, and a method for controlling a menu thereof.

A method for providing a menu of a display apparatus according to an exemplary embodiment includes dividing the display apparatus into a plurality of areas, and displaying a plurality of images on each of the plurality of areas, displaying a simultaneous control menu which controls the plurality of images simultaneously in response to a predetermined first user command being input, and displaying an individual control menu which controls one of the plurality of images in response to a predetermined second user command being input.

The displaying the simultaneous control menu may include displaying the simultaneous control menu over the plurality of areas, and the displaying the individual control menu may include displaying the individual control menu in an area of the plurality of areas where the one image to be controlled is displayed.

The displaying the simultaneous control menu may include displaying information indicating that the plurality of areas are controlled simultaneously in the simultaneous control menu, and the displaying the individual control menu may include displaying information indicating the one image to be controlled in the individual control menu.

The displaying the individual control menu may include displaying an indicator on the individual control menu and the one image to be controlled by the individual control menu in order to indicate the one image to be controlled by the individual control menu.

The displaying the individual control menu may include inputting a user command in an input device to indicate an area among the plurality of areas, and determining the area indicated by the input device, and setting an image displayed on the determined area as the one image to be controlled by the individual control menu.

The displaying the individual control menu may include changing the one image to be controlled by the individual control menu according to a selected direction button where a user command is input, from among a plurality of direction buttons on an input device.

The displaying the individual control menu may include recognizing a user motion, and changing the one image to be controlled by the individual control menu according to a direction of the recognized user motion.

The predetermined first user command may be a command in which a predetermined first button is selected on a remote controller, such that the display apparatus is controlled according to the predetermined first user command, and the predetermined second user command may be the command in which a predetermined second button is selected on a remote controller, such that the display apparatus is controlled according to the predetermined second user command.

A display apparatus according to an exemplary embodiment includes a display device which divides the display apparatus into a plurality of areas, and displays a plurality of images on each of the plurality of areas, an input device which receives a user command, and a controller which, if a predetermined first user command is input as the user command, displays a simultaneous control menu for controlling the plurality of images simultaneously, and if a predetermined second user command is input as the user command, displays an individual control menu for controlling one of the plurality of images.

The controller may control the display device to display the simultaneous control menu over the plurality of areas, and controls the display device to display the individual control menu in an area of the plurality of areas where the one image to be controlled is displayed.

The controller may control the display device to display information indicating that the plurality of areas are controlled simultaneously in the simultaneous control menu, and controls the display device to display information indicating the one image to be controlled in the individual control menu.

The controller may control the display device to display an indicator on the individual control menu and the one image to be controlled by the individual control menu in order to indicate the one image to be controlled by the individual control menu.

The apparatus may further include a sensor which senses an area, from among the plurality of areas, indicated by the input device, and the controller may determine the area indicated by the input device through the sensor, and set an image displayed on the determined area as the one image to be controlled by the individual control menu.

The controller may change the one image to be controlled by the individual control menu according to a selected direction button, from among a plurality of direction buttons on the input device.

The input device may include a motion input device which receives a user motion, and the controller may recognize the user motion input through the input device, and change the one image to be controlled by the individual control menu according to a direction of the recognized user motion.

The predetermined first user command may be the user command in which a predetermined first button is selected on the input device, and the predetermined second user command may be the user command in which a predetermined second button is selected on the input device.

A method for providing a menu of a display apparatus according to another exemplary embodiment includes dividing a display screen of the display apparatus into a plurality of areas, displaying a plurality of images on each of the plurality of areas, and displaying the menu which controls at least one of the plurality of images. The menu which controls at least one of the plurality of images may overlap the at least one of the plurality of images.

### BRIEF DESCRIPTION OF THE DRAWINGS

The above and/or other aspects of the exemplary embodiments will be more apparent by describing certain exemplary embodiments with reference to the accompanying drawings, in which:

FIG. 1 is a block diagram illustrating a configuration of a display apparatus according to an exemplary embodiment;

FIG. 2 is a block diagram illustrating a detailed configuration of a display apparatus according to an exemplary embodiment;

FIGS. 3 to 8 are views illustrating a simultaneous control menu or an individual control menu provided by a display apparatus according to various exemplary embodiments; and

FIG. 9 is a flowchart provided to explain a method for controlling a menu of a display apparatus according to an exemplary embodiment.

### DETAILED DESCRIPTION OF EXEMPLARY EMBODIMENTS

Certain exemplary embodiments are described in detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

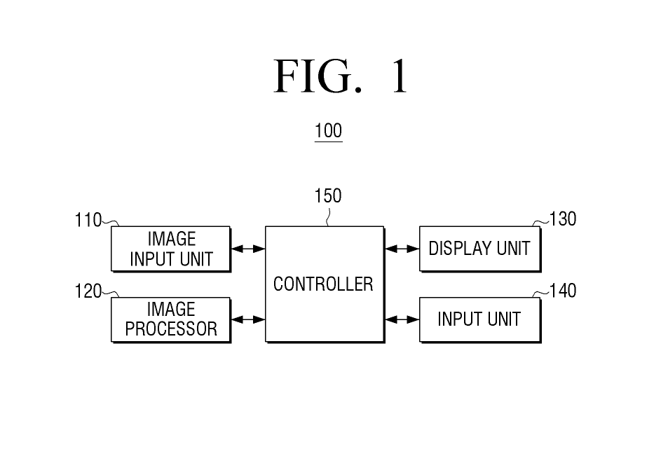

FIG. 1 is a block diagram illustrating a configuration of a display apparatus according to an exemplary embodiment. As illustrated in FIG. 1, a display apparatus 100 comprises an image input unit 110, an image processor 120, a display unit 130, an input unit 140, and a controller 150. In this case, the display apparatus 100 may be a smart television, but this is only an example. The display apparatus 100 may be realized as various display apparatuses, such as tablet PC, smart phone, projection television, etc. Meanwhile, the display apparatus 100 according to an exemplary embodiment may be a display apparatus capable of outputting images having Ultra High Definition (UHD)-level resolution (7680×4320).

The image input unit 110 receives image data from a plurality of sources. Specifically, the image input unit 110 may receive broadcast data from an external broadcasting station, image data from an external apparatus (for example, set-top box, DVD player, BD player, etc.) and Internet web page data via a network.

The image processor 120 performs signal processing so that an image input through the image input unit 110 can be displayed by the display unit 130. Specifically, the image processor 120 may perform signal processing, such as video decoding, format analysis, video scaling, etc., and operations such as adding a GUI, etc., with respect to a 3D image input to the image input unit 110.

In particular, the image processor 120, according to an exemplary embodiment, may be realized as a plurality of image processing modules in order to display a plurality of images on each of a plurality of areas of a display screen.

The display unit 130 displays image data, which is image processed by the image processor 120. In this case, the display unit 130 may be divided into a plurality of areas, and display a plurality of image data on each of the plurality of areas simultaneously. For example, the display unit 130 may divide a display screen into four areas, and display the first to the fourth images on each of the four areas respectively.

The input unit 140 receives a user command to control the display apparatus 100. In particular, the input unit 140 may receive the first user command to generate a simultaneous control menu for controlling a plurality of images displayed on a plurality of areas simultaneously, and the second user command to generate an individual control menu for controlling one of a plurality of images displayed on a plurality of areas individually. Meanwhile, the input unit 140, according to an exemplary embodiment, may be realized as a remote controller, but this is only an example. The input unit 140 may be realized as various input apparatus, such as touch screen, mouse, pointing device, etc.

The controller 150 controls overall operations of the display apparatus 100 according to a user command input through the input unit 140. In particular, if the predetermined first user command is input through the input unit 140 while a plurality of images are displayed on each of a plurality of areas of the display unit 130 respectively, the controller 150 controls the display unit 130 to display a simultaneous control menu to control the plurality of images simultaneously. Alternatively, if the predetermined second user command is input through the input unit 140 while a plurality of images are displayed on each of a plurality of areas of the display unit 130 respectively, the controller 150 controls the display unit 130 to display an individual control menu to control one of the plurality of images.

Specifically, if the predetermined first user command (e.g., a user command to select a predetermined first button of a remote controller) is input through the input unit 140 while a plurality of images are displayed on each of a plurality of areas of the display unit 130 respectively, the controller 150 controls the display unit 130 to display a simultaneous control menu to control the plurality of images simultaneously. In this case, the controller 140 may control the display unit 130 to display a simultaneous control menu over the plurality of image. In addition, the controller 140 may control the display unit 130 to display information that a menu in the simultaneous control menu controls the plurality of areas simultaneously (e.g., the title of “simultaneous control menu”).

Alternatively, if the predetermined second user command (for example, a user command to select a predetermined second button of a remote controller) is input through the input unit 140 while the simultaneous control menu is displayed, the controller 150 may control the display unit 130 to display an individual control menu to control one of the plurality of images. In this case, the controller 150 may control the display unit 130 to display the individual control menu within an area where an image to be controlled is displayed. In addition, the controller 150 may control the display unit 130 to display information on an image to be controlled within the individual control menu. For example, the controller 150 may control the display unit 130 to display the title of an image to be controlled within the individual control menu. Further, in order to represent an image which is controlled by the individual control menu, the controller 150 may control the display unit 130 to display the same indicator (e.g., highlight, etc.) on the individual control menu and each image to be controlled by the individual control menu.

The controller 150 may change an image to be controlled by the individual control menu according to a user command input through the input unit 140. Specifically, if the input unit 140 is a remote controller, the controller 150 may change an image to be controlled by the individual control menu according to a direction button, from among direction buttons provided on a remote controller. In addition, the controller 150 may toggle an image to be controlled by a specific button on a remote controller. Therefore, the image to be controlled is selected in the individual control menu.

If the display apparatus 100 includes a sensor (not shown) which senses an area indicated by the input unit 140, the controller 150 may determine an area which is indicated by the input unit, from among a plurality of areas, through the sensor. Further, the controller 150 may set an image displayed on the determined area as an image to be controlled by the individual control menu.

In addition, if the input unit 140 includes a motion input unit which receives a user motion, the controller 150 may recognize the user motion input through the motion input unit, and may change an image to be controlled by the individual control menu, according to the direction of the recognized user motion.

As described above, the display apparatus 100 allows a user to control a plurality of images displayed on a display screen simultaneously or individually. Therefore, user convenience may be improved.

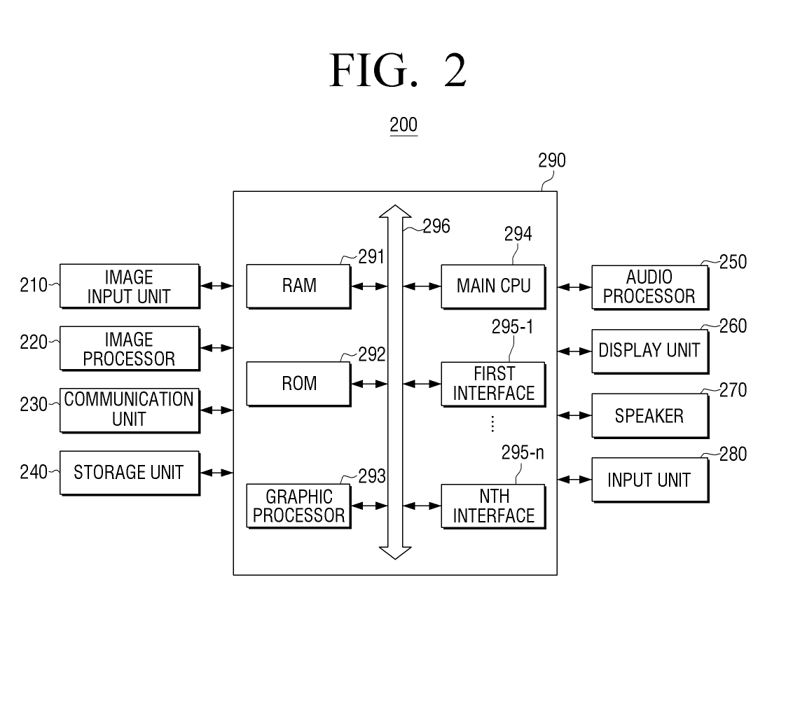

Hereinafter, the exemplary embodiment will be explained in greater detail with reference to FIGS. 2 to 8. FIG. 2 is a block diagram illustrating a detailed configuration of a display apparatus 200 according to an exemplary embodiment. As illustrated in FIG. 2, the display apparatus 200 comprises an image input unit 210, an image processor 220, a communication unit 230, a storage unit 240, an audio processor 250, a display unit 260, a speaker 270, an input unit 280, and a controller 290.

FIG. 2 is a view illustrating each component comprehensively, by taking a case where the display apparatus 200 is an apparatus providing various functions, such as a communication function, broadcast reception function, video reproduction function, and display function. However, the various functions are merely provided as examples. Therefore, some of the components illustrated in FIG. 2 may be omitted or changed, or other components may be added, depending on exemplary embodiments.

The image input unit 210 receives image data through various sources. Specifically, the image input unit 210 may receive broadcast data from an external broadcasting station, and image data from an external apparatus (for example, set-top box, DVD apparatus, and USB apparatus). In addition, the image input unit 210 may receive web page image data via an external network.

The image processor 220 is a component which processes image data received from the image input unit 210. The image processor 220 may perform various image processing, such as decoding, scaling, noise filtering, frame rate conversion, resolution conversion, etc., with respect to image data. Meanwhile, the image processor 220, according to an exemplary embodiment, may include a plurality of image processing modules in order to display a plurality of images on the display unit 260 simultaneously.

The communication unit 230 is a component to perform communication with various types of external apparatuses according to various types of communication methods. The communication unit 230 may comprise various communication chips, such as a WiFi chip, a Bluetooth chip, a Near Field Communication (NFC) chip, a wireless communication chip, etc. In this case, the WiFi chip, the Bluetooth chip, and the NFC chip perform communication according to a WiFi method, a Bluetooth method, and an NFC method respectively. The NFC chip refers to a chip which operates according to an NFC method by using 13.56 MHz, from among various RF-ID frequency bands such as 135 kHz, 13.56 MHz, 433 MHz, 860-960 MHz, 2.45 GHz, etc. When the WiFi chip or the Bluetooth chip is used, various connection information, such as SSID, session key, etc., is received/transmitted in advance so that communication can be performed using the same, and various information can be received/transmitted. The wireless communication chip refers to a chip which performs communication according to various communication standards, such as IEEE, Zigbee, 3G (3rd Generation), 3GPP (3rd Generation Partnership Project), LTE (Long Term Evolution), etc.

The storage unit 240 stores various modules to drive the display apparatus 200. For example, the storage unit 240 may store software, including a base module, a sensing module, a communication module, a presentation module, a web browser module, and a service module. In this case, the base module is a basic module which processes a signal transmitted from each hardware included in the display apparatus 200, and transmits the processed signal to an upper layer module. The sensing module collects information from various sensors, and analyzes and manages the collected information. The sensing module may include a face recognition module, a voice recognition module, a motion recognition module, an NFC recognition module, etc. The presentation module is a module to compose a display screen. The presentation module may include a multimedia module to reproduce and output multimedia contents, and a UI rendering module to perform UI and graphic processing. The communication module is a module to perform communication with outside. The web browser module is a module to access a web server by performing web browsing. The service module is a module including various applications to provide various services.

As described above, the storage unit 240 may include various program modules, but some of the various program modules may be omitted, changed, or added according to the type and characteristics of the display apparatus 200. For example, if the display apparatus 200 is realized as a tablet PC, the basic module may further include a determination module to determine a GPS-based location, and the sensing module may further include a sensing module to sense the operation of a user.

The audio processor 250 is a component which performs processing with respect to audio data. The audio processor 250 may perform various processing such as decoding, amplifying, noise filtering, etc., with respect to audio data. The audio data, processed by the audio processor 250, may be output to the speaker 270.

The display unit 260 displays at least one of a video frame which is generated as the image processor 220 processes image data received from the image input unit 210, and various screens which are generated by a graphic processor 293. In particular, the display unit 260 may divide a display screen into a plurality of areas and display a plurality of images input through the image input unit 210 on each of the plurality of areas.

The speaker 270 is a component which outputs various alarm sounds or voice messages, as well as various audio data processed by the audio processor 250.

The input unit 280 receives a user command to control overall operations of the display apparatus 200. In this case, the input unit 280 may be realized as a remote controller, including a plurality of buttons (e.g., a button for generating a menu, a button for moving left, right, up, or down, a button for selection, etc.). However, the input unit 280 being a remote controller is only an example. The input unit 280 may be realized as other input apparatuses capable of controlling the display apparatus 200, such as a touch panel, a pointing device, etc.

In particular, the input unit 280 may receive the first user command to generate the simultaneous control menu for controlling a plurality of images displayed on the display unit 260, or the second user command to generate the individual control menu for controlling one of a plurality of images displayed on the display unit 260. In this case, if the input unit 280 is a remote controller, the first user command may be a user command to select the predetermined first button of the remote controller, and the second command may be a user command to select the predetermined second button of the remote controller. The first button and the second button are different from each other, but they may be realized as the same button. In this case, if the first button is selected once, the controller 290 may display the simultaneous control menu, and if the first button is selected once more, the controller 290 may the display unit 260 to change the simultaneous control menu to the individual control menu and display the individual control menu.

The controller 290 controls the overall operations of the display apparatus 200 using various programs stored in the storage unit 240.

As illustrated in FIG. 2, the controller 290 comprises a RAM 291, a ROM 292, a graphic processor 293, a main CPU 294, first to nth interface 295-1˜295-n, and a bus 296. In this case, the RAM 291, the ROM 292, the graphic processor 293, the main CPU 294, and the first to nth interface 295-1˜295-n may be connected to each other through the bus 296.

The ROM 292 stores a set of commands for system booting. If a turn-on command is input and power is supplied, the main CPU 294 copies an O/S stored in the storage unit 240 in the RAM 291 according to a command stored in the ROM 292, and executes the O/S to boot the system. Once the system booting is completed, the main CPU 294 copies various application programs stored in the storage unit 240 in the RAM 291, and performs various operations by executing the application programs copied in the RAM 291.

The graphic processor 293 generates a screen including various objects, such as icon, image, text, etc., using an operator (not shown) and a renderer (not shown). The operator calculates property values, such as coordinates, shape, size, color, etc., of a screen where each object is displayed, according to a layout of a screen using a control command received from the user command input unit 280. The renderer generates a screen of various layouts, including an object based on the property values calculated by the operator. The screen generated by the renderer is displayed within a display area of the display unit 210.

The main CPU 294 performs booting, using the O/S stored in the storage unit 240. In addition, the main CPU 294 performs various operations using various programs, contents, data, etc., stored in the storage unit 240.

The first to nth interface 295-1 to 295-n are connected to the above-described various components. One of the interfaces may be a network interface, which is connected to an external apparatus through network.

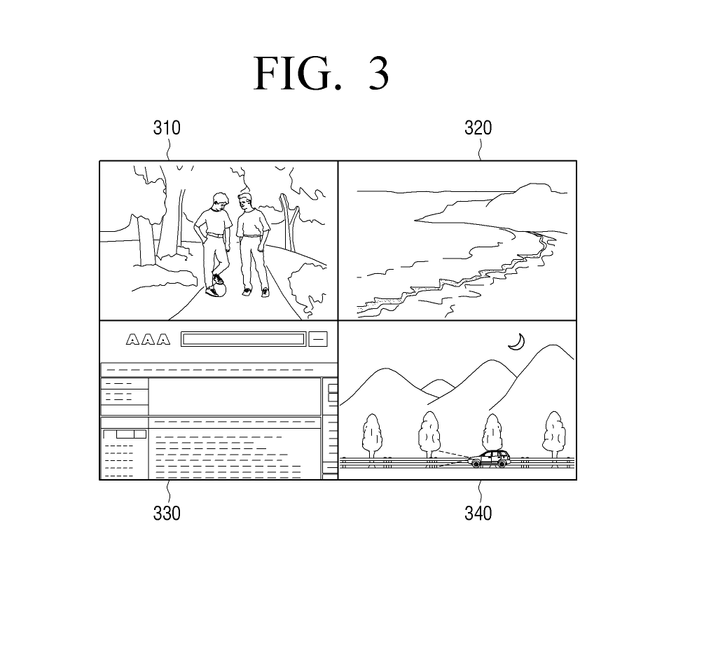

In particular, the controller 290 may divide the display unit 260 into a plurality of areas, and display a plurality of images input through the image input unit 290 on each of the plurality of areas. For example, as illustrated in FIG. 3, the controller 290 may control the display unit 260 to display the first broadcast data received from a broadcasting station as the first image 310, the second broadcast data received from a broadcasting station as the second image 320, the webpage data as the third image 330, and the image data received from an external apparatus as the fourth image 340 on one screen.

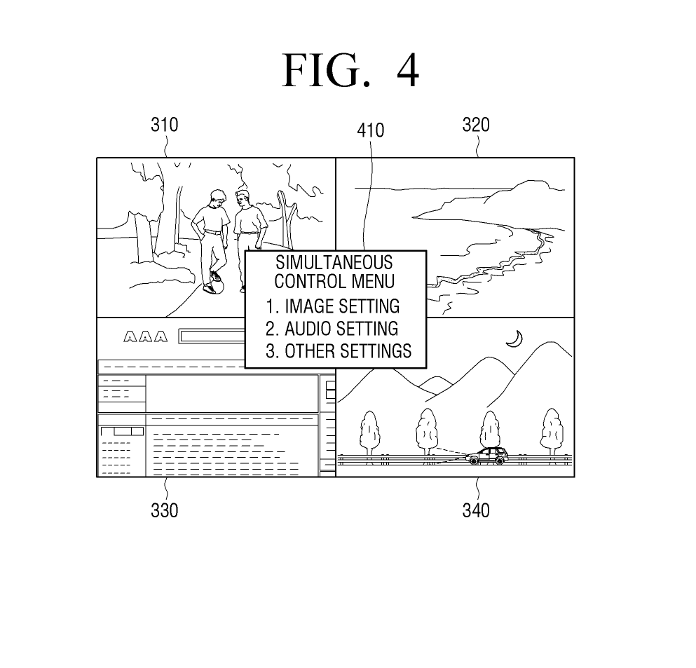

If the predetermined first user command is input through the input unit 280 while a plurality of images are displayed on a plurality of areas of the display unit 260 simultaneously, the controller 290 may display a simultaneous control menu for controlling the plurality of images simultaneously. For example, as illustrated in FIGS. 3-4, if the predetermined first user command (e.g., a user command to select the first button of the remote controller) is input through the input unit 280 while the first to the fourth images 310, 320, 330, 340 are displayed on the display unit 260, the controller 290 may control the display unit 260 to display a simultaneous control menu 410. As illustrated in FIG. 4, the simultaneous control menu 410 is a menu for changing the setting of a plurality of images displayed on a plurality of areas of the display unit 260, and may include an image setting item for image setting a plurality of images, an audio setting item for audio setting a plurality of images, and an image setting item for other settings of a plurality of images.

In this case, the controller 290 may control the display unit 260 to display the simultaneous control menu 410 over the plurality of images. For example, the controller 290 may control the display unit 260 to display the simultaneous control menu 410 such that the simultaneous control menu 410 is overlapped with some of the first image to the fourth image 310, 320, 330, 340.

In addition, the controller 290 may control the display unit 260 to display information that a plurality of images can be controlled by a menu in the simultaneous control menu 410 simultaneously. For example, as illustrated in FIG. 4, the simultaneous control menu 410 may include text information indicating that the title of a menu is “a simultaneous control menu”.

In the above exemplary embodiment regarding FIG. 4, the simultaneous control menu 410 is displayed over all of the plurality of areas. However, this is only an example. The simultaneous control menu 410 may be displayed in at least one of a plurality of images. In this case, the simultaneous control menu 410 may display information that a plurality of images can be controlled simultaneously.

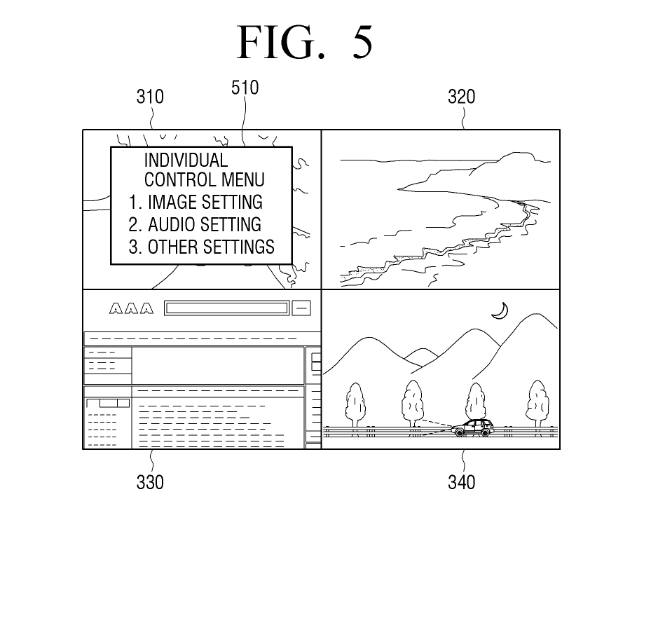

In addition, if the predetermined second user command is input through the input unit 280 while a plurality of images are displayed on a plurality of areas of the display unit 260 simultaneously, the controller 290 may display an individual control menu for controlling one of the plurality of images individually. For example, as illustrated in FIGS. 3 and 5, if the predetermined second user command (e.g., a user command to select the second button of the remote controller) is input through the input unit 280 while the first to the fourth images 310, 320, 330, 340 are displayed on the display unit 260, the controller 290 may control the display unit 260 to display an individual control menu 510. As illustrated in FIG. 5, the individual control menu 510 is a menu for changing the setting of one of a plurality of images displayed on a plurality of areas of the display unit 260, and may include an image setting item for image setting one image, an audio setting item for audio setting one image, and an image setting item for other settings of one image.

In this case, the controller 290 may control the display unit 260 to display the individual control menu 510 in an area where an image to be controlled is displayed. For example, as illustrated in FIG. 5, the controller 290 may control the display unit 260 to display the individual control menu 410 within the first image 310 to be controlled.

In addition, the controller 290 may control the display unit 260 to display information that one of a plurality of images can be controlled by a menu in the individual control menu 510. For example, as illustrated in FIG. 5, the individual control menu 510 may include text information indicating that the title of a menu is “an individual control menu”.

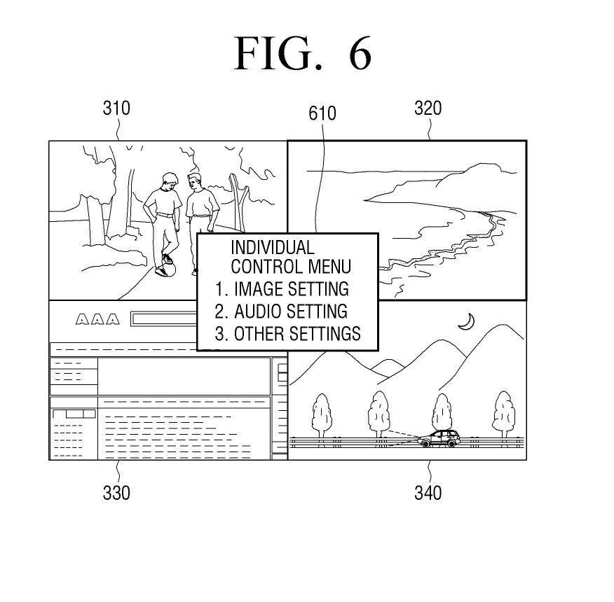

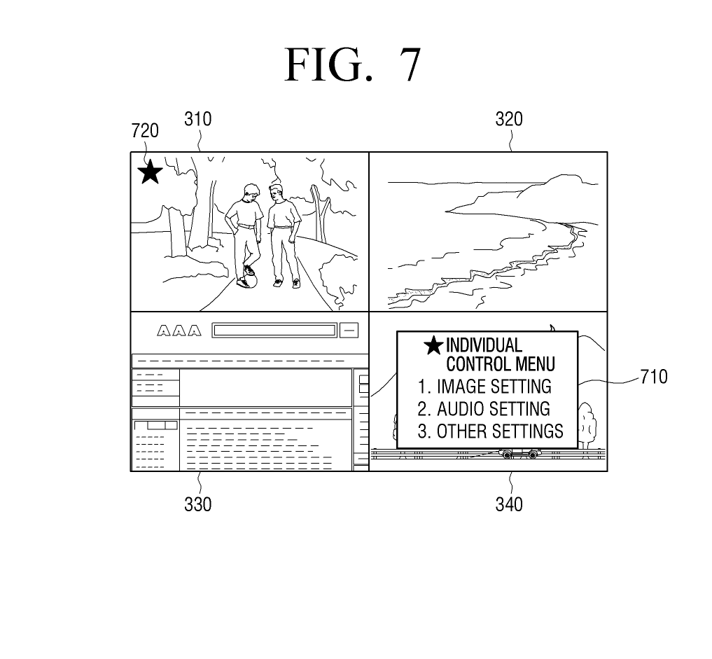

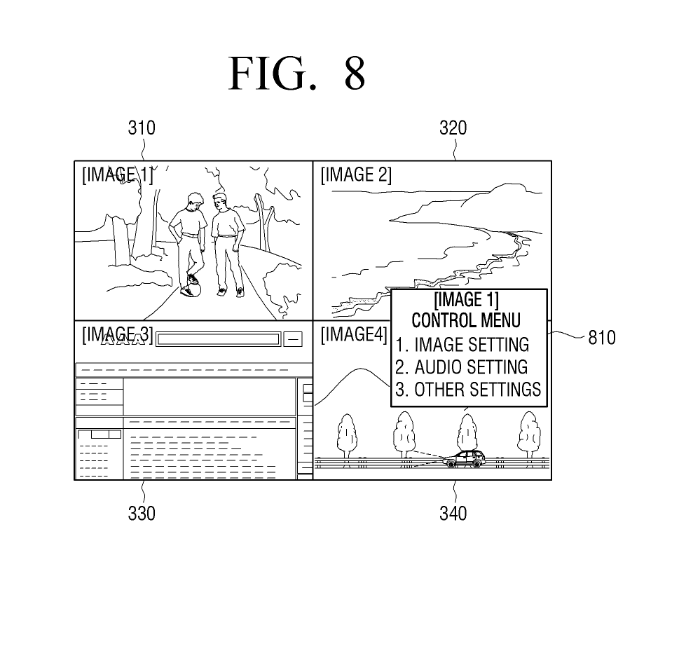

In FIG. 5, the individual control menu 510 is displayed within an image to be controlled, but this is only an example. The individual control menu 510 may be displayed outside the image to be controlled. In this case, in order for a user to recognize an image that is controlled by the individual control menu, the controller 290 may control the display unit 260 to display an indicator in the individual control menu and each image to be controlled by the individual control menu. For example, as illustrated in FIG. 6, the controller 290 may control the display unit 260 to display a highlight on each of an individual control menu 610 and the second image 320, which is an image to be controlled by the individual control menu 610. In another exemplary embodiment, as illustrated in FIG. 7, the controller 290 may control the display unit 260 to display a certain mark (e.g., a star) on each of an individual control menu 710 and the first image 310 to be controlled by the individual control menu 710. Alternatively, as illustrated in FIG. 8, the controller 290 may control the display unit 260 to display within the individual control menu text information such as “image 1”, “image 2”, “image 3”, and “image 4” on each of a plurality of areas, and display “image 1”, which is text information corresponding to the first image 310 to be controlled by the individual control menu 810.

In addition, the controller 290 may change an image to be controlled by the individual control menu 510, from among a plurality of images according to a user command.

According to an exemplary embodiment, if the display apparatus 200 includes a sensor (not shown) (e.g., an IR sensor) which determines an area indicated by the input unit 280, the controller 290 may determine an area indicated by the input unit which receives a user command from among a plurality of areas. In addition, the controller 290 may set an image which is displayed on the determined area as an image to be controlled by the individual control menu 510. For example, if an area indicated by the input unit 280 is changed from the first area to the second area, the controller 290 may sense through the sensor that the area indicated by the input unit 280 is changed, and change the image to be controlled by the individual control menu 510 from the first image 310 of the first area to the second image 320 of the second area.

According to another exemplary embodiment, if the input unit 280 is a remote controller, the controller 290 may change an image to be controlled by the individual control menu 510 according to a direction button, which is selected from among direction buttons on the remote controller. For example, if the individual control menu 510 is controlling the first image 310 and a downward direction button of the remote controller is selected, the controller 290 may change the image to be controlled by the individual control menu 510 from the first image 310 to the third image 330 which is located below the first image 310.

In addition, the controller 290 may toggle an image to be controlled by the individual control menu 510, as predetermined two buttons are selected in a row. For example, if the predetermined second button is selected once, the controller 290 may set the first image as an image to be controlled by the individual control menu 510, if the predetermined second button is selected again, the controller 290 may change the image to be controlled by the individual control menu 510 from the first image to the second image, if the predetermined second button is selected once again, the controller 290 may change the image to be controlled by the individual control menu 510 from the second image to the third image, and if the predetermined second button is selected again, the controller 290 may change the image to be controlled by the individual control menu 510 from the third image to the fourth image.

According to another exemplary embodiment, if the input unit 280 is a motion input unit, the controller 290 may recognize a user motion input through the motion input unit, and change an image to be controlled by the individual control menu according to the direction of the recognized user motion. For example, if a slap motion in a right direction is input through the motion input unit while the individual control menu 510 is controlling the first image 310, the controller 290 may change the image to be controlled by the individual control menu 510 from the first image 310 to the second image 320, which is located on the right side of the first image 310.

As described above, the display apparatus 200 allows a user to control a plurality of images displayed on a display screen simultaneously, or to control only some of them. Thus, user convenience may be improved.

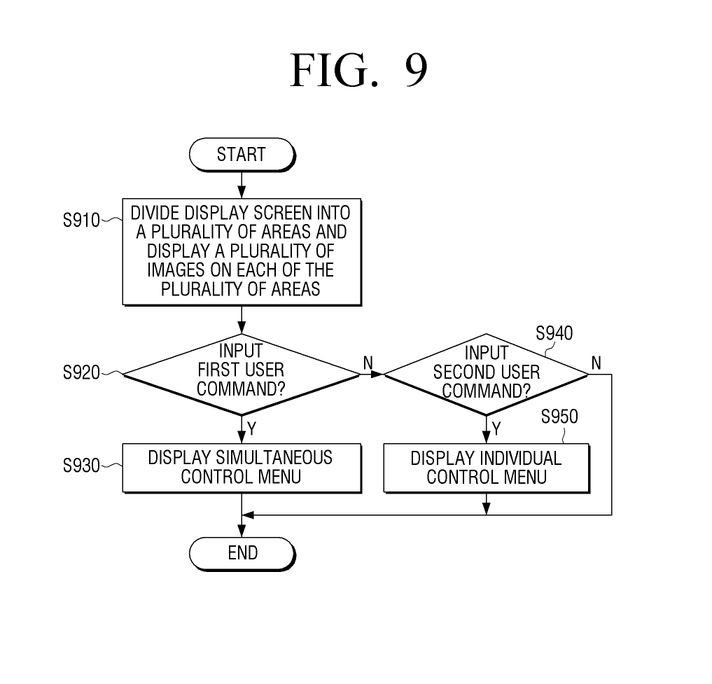

The method for providing a menu of the display apparatus 100 will be explained in detail with reference to FIG. 9.

The display apparatus 100 divides a display screen into a plurality of areas, and displays a plurality of images on each of the plurality of areas (S910). For example, as illustrated in FIG. 3, the display apparatus 100 may display four images on a display screen.

Subsequently, the display apparatus 100 determines whether the first use command is input (S920). In this case, the first user command may be a command to select the first button on the input unit 240.

If the first user command is input (5920-Y), the display apparatus 100 displays a simultaneous control menu (S930). The simultaneous control menu is a menu for changing the settings of a plurality of images displayed on the plurality of areas of the display screen at the same time. In this case, as illustrated in FIG. 4, the simultaneous control menu may be displayed over the plurality of areas, and information indicating that the menu in the simultaneous control menu is a simultaneous control menu may be displayed.

If the first user command is not input (S920-N), the display apparatus 100 determines whether the second user command is input (S940).

If the second user command is input (S940-Y), the display apparatus 100 displays an individual control menu (S950). In this case, the individual control menu is a menu for changing the setting of one of the plurality of images displayed on the display screen individually. In this case, as illustrated in FIG. 5, the individual control command may be displayed in the image to be controlled. As illustrated in FIGS. 6 to 8, the individual control command may include an indicator, which is the same as the indicator for the image to be controlled.

As described above, the method for providing a menu of the display apparatus 100 allows a user to control a plurality of images displayed on a display screen simultaneously or individually. Thus, user convenience may be improved.

Meanwhile, in the above exemplary embodiment, the predetermined first user command or the second user command is a user command to select the predetermined first button or the second button on the input unit 140. However, this is only an example. For example, the predetermined first user command may be a user voice command, such as “simultaneous menu”, and the second user command may be a user voice command, such as “individual menu” or “first image menu”.

The method for providing a menu of a display apparatus according to various exemplary embodiments may be realized as a program, and provided in the display apparatus.

Specifically, a non-transitory computer readable medium which stores a program including the step of first displaying of dividing a display screen into a plurality of areas and displaying a plurality of images on each of the plurality of areas; the step of second displaying of, if the predetermined first user command is input, displaying a simultaneous control menu for controlling the plurality of images simultaneously; and the step of third displaying of, if the predetermined second user command is input, changing the simultaneous control menu to an individual control menu for controlling one of the plurality of images and displaying the same may be provided.

The non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as CD, DVD, hard disk, Blu-ray disk, USB, memory card, and ROM.

In another exemplary embodiment of FIGS. 1-2, any of the image input unit 110, the image processor 120, the display unit 130, the input unit 140, and the motion input unit may include at least one processor for performing their respective functions. Further, any of the image input unit 110, the image processor 120, the display unit 130, the input unit 140, and the motion input unit may include a circuit or a hardware module for performing their respective functions.

The foregoing embodiments and advantages are merely exemplary and are not to be construed as limiting the exemplary embodiments. The exemplary embodiments can be readily applied to other types of apparatuses. Also, the description of the exemplary embodiments is intended to be illustrative, and not to limit the scope of the claims. Therefore, many alternatives, modifications, and variations will be apparent to those skilled in the art.

What is claimed is:

1. A method for providing a menu of a display apparatus, comprising:
dividing the display apparatus into a plurality of areas, and displaying a plurality of images on each of the plurality of areas; displaying a simultaneous control menu which controls the plurality of images simultaneously in response to a predetermined first user command being input; and
displaying an individual control menu which controls one of the plurality of images in response to a predetermined second user command being input.

2. The method as claimed in claim 1, wherein the displaying the simultaneous control menu comprises:
displaying the simultaneous control menu over the plurality of areas, and
wherein the displaying the individual control menu comprises: displaying the individual control menu in an area of the plurality of areas where the one image to be controlled is displayed.

3. The method as claimed in claim 1, wherein the displaying the simultaneous control menu comprises:
displaying information indicating that the plurality of areas are controlled simultaneously in the simultaneous control menu, and
wherein the displaying the individual control menu comprises:
displaying information indicating the one image to be controlled in the individual control menu.

4. The method as claimed in claim 1, wherein the displaying the individual control menu comprises:
displaying an indicator on the individual control menu and the one image to be controlled by the individual control menu in order to indicate the one image to be controlled by the individual control menu.

5. The method as claimed in claim 1, wherein the displaying the individual control menu comprises:
inputting a user command in an input device to indicate an area among the plurality of areas, and determining the area indicated by the input device; and
setting an image displayed on the determined area as the one image to be controlled by the individual control menu.

6. The method as claimed in claim 1, wherein the displaying the individual control menu comprises:
changing the one image to be controlled by the individual control menu according to a selected direction button where a user command is input, from among a plurality of direction buttons on an input device.

7. The method as claimed in claim 1, wherein the displaying the individual control menu comprises:
recognizing a user motion; and
changing the one image to be controlled by the individual control menu according to a direction of the recognized user motion.

8. The method as claimed in claim 1, wherein the predetermined first user command is a command in which a predetermined first button is selected on a remote controller, such that the display apparatus is controlled according to the predetermined first user command, and
the predetermined second user command is the command in which a predetermined second button is selected on the remote controller, such that the display apparatus is controlled according to the predetermined second user command.

9. A display apparatus, comprising:
a display device which divides the display apparatus into a plurality of areas, and displays a plurality of images on each of the plurality of areas;
an input device which receives a user command; and
a controller which, if a predetermined first user command is input as the user command, displays a simultaneous control menu for controlling the plurality of images simultaneously, and if a predetermined second user command is input as the user command, displays an individual control menu for controlling one of the plurality of images.

10. The apparatus as claimed in claim 9, wherein the controller controls the display device to display the simultaneous control menu over the plurality of areas, and controls the display device to display the individual control menu in an area of the plurality of areas where the one image to be controlled is displayed.

11. The apparatus as claimed in claim 9, wherein the controller controls the display device to display information indicating that the plurality of areas are controlled simultaneously in the simultaneous control menu, and controls the display device to display information indicating the one image to be controlled in the individual control menu.

12. The apparatus as claimed in claim 9, wherein the controller controls the display device to display an indicator on the individual control menu and the one image to be controlled by the individual control menu in order to indicate the one image to be controlled by the individual control menu.

13. The apparatus as claimed in claim 9, further comprising:
a sensor which senses an area, from among the plurality of areas, indicated by the input device,
wherein the controller determines the area indicated by the input device, through the sensor, and sets an image displayed on the determined area as the one image to be controlled by the individual control menu.

14. The apparatus as claimed in claim 9, wherein the controller changes the one image to be controlled by the individual control menu according to a selected direction button, from among a plurality of direction buttons on the input device.

15. The apparatus as claimed in claim 9, wherein the input device comprises a motion input device which receives a user motion,
wherein the controller recognizes the user motion input through the input device, and changes the one image to be controlled by the individual control menu according to a direction of the recognized user motion.

16. The apparatus as claimed in claim 9, wherein the predetermined first user command is the user command in which a predetermined first button is selected on the input device, and
the predetermined second user command is the user command in which a predetermined second button is selected on the input device.

17. A method for providing a menu of a display apparatus, comprising:
dividing a display screen of the display apparatus into a plurality of areas;
displaying a plurality of images on each of the plurality of areas; and
displaying the menu which controls at least one of the plurality of images,
wherein the menu which controls at least one of the plurality of images overlaps the at least one of the plurality of images.

18. The method as claimed in claim 17, wherein the menu simultaneously controls all of the plurality of images in response to a first user command being input.

19. The method as claimed in claim 17, wherein the menu controls one of the plurality of images in response to a second user command being input.

20. The method as claimed in claim 19, wherein the menu only overlaps the one of the plurality of images in response to the second user command being input.
